(19) United States
(12) Patent Application Publication
(10) Pub. No.: US 2026/0220211 A1
(43) Pub. Date: Jul. 30, 2026

(54) MULTI-STAGE ACTION DETERMINATION FOR CONTENT DELIVERY

(71) Applicant: Microsoft Technology Licensing, LLC, Redmond, WA (US)

(72) Inventors: Changshuai Wei, Lynnwood, WA (US); Benjamin Basil Zelditch, New York, NY (US); Xinyan Chen, Foster City, CA (US); Andre Assuncao Silva T Ribeiro, Twentynine Palms, CA (US); Jingyi Kenneth Tay, Singapore (SG)

(21) Appl. No.: 19/041,337

(22) Filed: Jan. 30, 2025

(51) Int. Cl. G06F 16/9535; G06Q 30/0601

(52) U.S. Cl. CPC G06F 16/9535; G06Q 30/0631

(57) ABSTRACT

Methods, systems, and apparatuses include receiving feature data for a user of an online system and a first content delivery action for content delivery on the online system. The feature data is sent to a trained propensity machine learning model. Propensity data is received from the trained propensity model. A first content delivery decision is determined for the user and the first content delivery action using the propensity data. Second feature data is received for the user and a second content delivery action for the content deliver. The second feature data is sent to the trained propensity model. Second propensity data is received from the trained propensity model. A second content delivery decision is determined for the user and the second content delivery action using the second propensity data. The content is delivered to the user on the online system based on the first and the second content delivery decisions.

### TECHNICAL FIELD

The present disclosure generally relates to content delivery, and more specifically, relates to content delivery using multi-stage content delivery action determination.

### BACKGROUND ART

Software applications use computer networks to distribute digital content to user computing devices. On user devices, digital content can be displayed through slots of a graphical user interface. For example, news feeds and home pages contain slots. When a user logs in to or opens a software application, or traverses to a new page of an application, the application may generate one or more requests for content to be displayed in one or more of the available slots.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a content delivery action determination component in accordance with some embodiments of the present disclosure.

FIG. 2 illustrates another example computing system that includes a content delivery action determination component in accordance with some embodiments of the present disclosure.

FIG. 3 illustrates another example computing system that includes a content delivery action determination component in accordance with some embodiments of the present disclosure.

FIG. 4 illustrates another example computing system that includes a content delivery action determination component in accordance with some embodiments of the present disclosure.

FIG. 5 is a flow diagram of an example method to deliver content using multi-stage content delivery action determination in accordance with some embodiments of the present disclosure.

FIG. 6 is a block diagram of an example computer system in which embodiments of the present disclosure can operate.

### DETAILED DESCRIPTION

A content delivery system distributes digital content to user devices through, for example, web sites, mobile apps, and VR/AR/MR (virtual reality, augmented reality, mixed reality) systems. A content delivery system distributes content to different users through an online network based on, for example, rules, targeting criteria, and/or machine learning model output. Examples of content distributions include distributions of job postings, user-generated content, connection recommendations, news updates, e-commerce, entertainment, education and training materials, and advertisements.

A content delivery system often includes or interacts with an automated content-to-request matching process, such as a real-time bidding (RTB) process. Automated content-to-request matching processes programmatically match digital content distributions to requests in real time. A request is, for example, a network message, such as an HTTP (HyperText Transfer Protocol) request for content, which is generated in connection with an online user interface event such as a click or a page load. The term click is used to refer to any type of action taken by a user with an input device or sensor, which causes a signal to be received and processed by the user's device, including mouse clicks, taps on touchscreen display elements, voice commands, gestures, haptic inputs, and/or other forms of user input. The content delivery system can log impressions, clicks, post-click and post-impression events, which the content delivery system can use to compute performance metrics.

Conventional content delivery systems are limited in their scope as the conventional systems focus on delivery of content as a singular content delivery action. For example, content delivery actions can include a product to recommend, whether or not to send a content recommendation, a time to send the content recommendations, a frequency at which to send the content recommendations, the content of the recommendation itself (e.g., what text, pictures, etc. to include), and bid prices for campaigns associated with the content, among others.

Conventional systems focus on only one of these content delivery actions and therefore lack the understanding of the interplay between the different variables. Accordingly, conventional content recommendation systems take long amounts of time and large amounts of training data to produce optimal content recommendations.

Additionally, these conventional systems train machine learning models to provide content recommendations based on short term reward goals rather than long term value metrics. For example, conventional systems choose whether to recommend content based on the likelihood that the user will subscribe to the service currently being recommended without considering the length of time the user will be subscribed or whether this subscription could affect the user's other interactions with content recommendations by the system. These conventional systems therefore provide content recommendations that rely on a small scale view and understanding of the user and their behavior without considering the longer term and broader reaching consequences of the current content recommendation.

Furthermore, these content systems focus on optimizing the likelihood for explicit positive reactions to content but do not often consider the likelihood of negative reactions in response to the content, especially negative implicit reactions to the content. For example, content distribution systems which recommend too much content, or which recommend content too frequently can cause a user to unsubscribe or otherwise ignore the content recommendations. Conventional content distribution systems focus on whether the user will interact with the content (e.g., subscribe to a service) without considering the possibilities for negative responses (such as unsubscribing or ignoring the content recommendations).

Aspects of the present disclosure address these and other problems by using content deliveries composed using multiple diverse content delivery actions increasing the amount of available data for training and allowing the content delivery system to learn the interplay between the different types of content delivery actions through multiple stages. The diversity of the types of content delivery actions and the number of content delivery actions included in a single content delivery increases the amount of useful training data for the content delivery system while also allowing the system to learn a broader understanding of the different aspects of the content delivery. For example, these recommendation systems can determine a product to send in a content recommendation during a first stage, can determine a time and/or frequency to send the content recommendation in a second stage, and can determine the actual content to include in the recommendation (e.g., what text, images, or other media to include in the recommendation) in the third stage. The determined response for a given content delivery action is referred to as a content action delivery decision. These recommendation systems further generate these content action delivery decisions for content delivery actions based on calculations of long term value for users of the system which takes into account not only the user's current reaction to the content recommendation (e.g., subscribing to a service) but also the user's future reactions to the content recommendation (e.g., length of time subscription is maintained) as well as reactions to future content. These long-term value considerations can also be used alongside more traditional short-term value considerations to create a system that is more robust in its recommendations as well as capable of using a larger amount of training data (e.g., from areas where short-term value considerations are not properly representative of the actual value received). Accordingly, the system is able to converge more quickly on content action delivery decisions for content delivery actions that are better optimized for both the users and the content creators. Additionally, these systems can make content action delivery decisions that balance multiple performance parameters and associated constraints across many different involved parties. For example, these systems use multi-objective optimization for performance parameters such as conversion propensity and complain propensity to maximize the conversions while keeping the complaints under a minimum constraint. This multi-objective optimization can be further performed for multiple different campaigns with different constraints, resulting in content action delivery decisions that take into account other relevant content action delivery decisions from the same system. For example, this multi-objective optimization checks constraints such as maximum number of notifications sent to a single user in a time period, ensuring that end users that are targeted by multiple campaigns are not inundated with a massive amount of content delivery. This results in an improved end user experience which minimizes the probability of negative reactions by end users while optimizing the long-term value results of the content delivery that does occur.

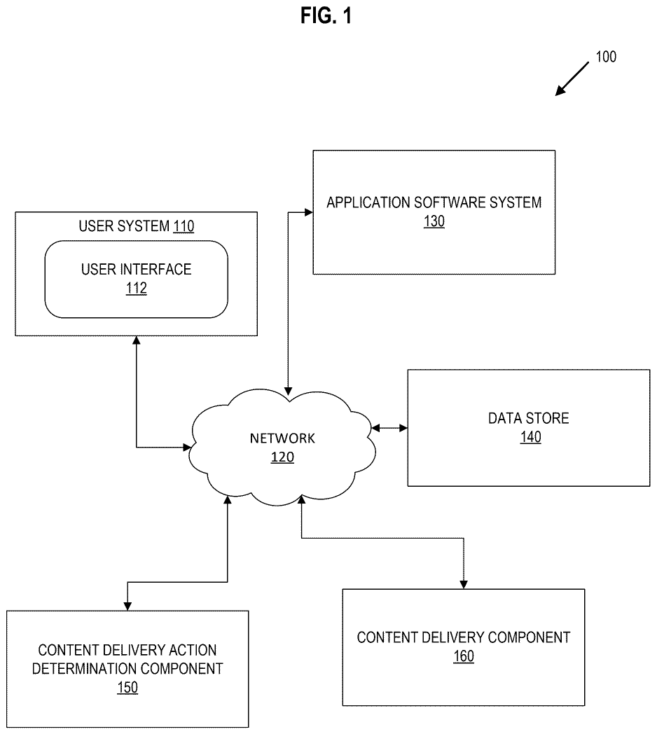

FIG. 1 illustrates an example computing system 100 that includes a content action delivery determination component 150 in accordance with some embodiments of the present disclosure. In the embodiment of FIG. 1, computing system 100 includes a user system 110, a network 120, an application software system 130, a data store 140, a content action delivery determination component 150, and a content delivery component 160. Each of these components of computing system 100 are described in more detail below. In some embodiments, the components of computing system 100 and their respective subcomponent are implemented on one or more of user devices, cloud servers and/or databases, and combinations thereof.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to interact with a webpage or application and view or otherwise perceive output that includes data produced by application software system 130. For example, user interface 112 can include a graphical user interface that includes a mechanism for entering a queries and viewing query results and/or other digital content such as the content deliveries described herein. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality and/or outputs provided by content action delivery determination component 150 and/or content delivery component 160. Examples of application software system 130 include but are not limited to online services including connections network software, such as social media platforms, and systems that are or are not be based on connections network software, such as general-purpose search engines, content distribution systems including media feeds, bulletin boards, and messaging systems, special purpose software such as but not limited to job search software, recruiter search software, sales assistance software, advertising software, learning and education software, enterprise systems, customer relationship management (CRM) systems, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

While not specifically shown, it should be understood that any of user system 110, application software system 130, data store 140, content action delivery determination component 150, and content delivery component 160 includes an interface embodied as computer programming code stored in computer memory that when executed causes a computing device to enable bidirectional communication with any other of user system 110, application software system 130, data store 140, content action delivery determination component 150, and content delivery component 160 using a communicative coupling mechanism. Examples of communicative coupling mechanisms include network interfaces, inter-process communication (IPC) interfaces and application program interfaces (APIs).

Data store 140 can include any combination of different types of memory devices. Data store 140 stores digital data used by user system 110, application software system 130, content action delivery determination component 150, and/or content delivery component 160. Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Each of user system 110, application software system 130, data store 140, content action delivery determination component 150, and content delivery component 160 is implemented using at least one computing device that is communicatively coupled to electronic communications network 120. Any of user system 110, application software system 130, data store 140, content action delivery determination component 150, and content delivery component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, content action delivery determination component 150, and/or content delivery component 160. User system 110 is configured to communicate bidirectionally with any of application software system 130, data store 140, content action delivery determination component 150, and/or content delivery component 160 over network 120.

The features and functionality of user system 110, application software system 130, data store 140, content action delivery determination component 150, and content delivery component 160 are implemented using computer software, hardware, or software and hardware, and can include combinations of automated functionality, data structures, and digital data, which are represented schematically in the figures. User system 110, application software system 130, data store 140, content action delivery determination component 150, and content delivery component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

The content action delivery determination component 150 determines multiple content delivery decisions for a single content delivery using a multi-stage content delivery decision process. For example, content action delivery determination component 150 receives a list of raw candidates for content delivery to a user as well as metadata associated with the user and the candidates and trains and/or executes machine learning models to determine multiple content action delivery decisions for content delivery of one or more of the raw candidates. Further details regarding the operations of content action delivery determination component 150 are described below.

The content delivery component 160 aggregates the content action delivery decisions into a single content delivery which is presented to a user based on the content delivery decisions. Further details regarding the operations of content delivery component 160 are described below.

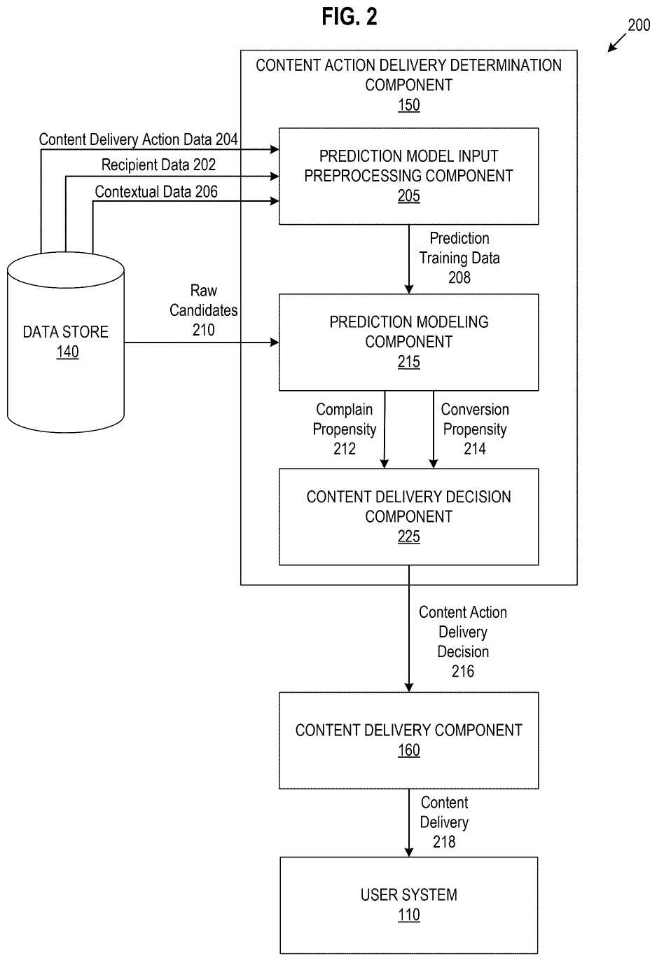

FIG. 2 illustrates another example computing system 200 that includes content action delivery determination component 150. As shown in FIG. 2, computing system 200 also includes data store 140, content delivery component 160, and user system 110. Content action delivery determination component 150 includes prediction model input preprocessing component 205, prediction modeling component 215, and content delivery decision component 225.

FIG. 2 illustrates computing system 200 with an information flow representing content delivery 218. Although illustrated as a single flow for simplicity, each content delivery 218 includes multiple different content action delivery decisions 216 that concern different aspects of the ultimate content delivery 218. In one example, a content delivery 218 is an advertisement sent to a user of user system 110. In such an example, each pass through content action delivery determination component 150 determines a different aspect of the content delivery (e.g., a different content action delivery decision). If the content delivery 218 is an email advertisement to a user of user system 110, each of these stages targets a different content delivery action (e.g., a different aspect of content delivery 218). In continuing with the above example, the first content delivery action targets which campaign to advertise to the user, the second content delivery action targets whether to send the advertisement or not, the third content delivery action targets the medium through which to send the advertisement, the fourth content delivery action targets the actual content of the advertisement, etc. It will be appreciated that different numbers and combinations of content delivery actions can be combined using computing system 200 to provide a content delivery 218 that is holistically tailored to the user of user system 100. Further details regarding these content delivery actions are described below.

As shown in FIG. 2, content action delivery determination component 150 receives feature data for a user of user system 110 and a content delivery action. For example, content action delivery determination component 150 receives feature data including recipient data 202, content delivery action data 204, and contextual data 206 from data store 140. In some embodiments, data store 140 represents a data pipeline for recipient data 202, content delivery action data 204, and contextual data 206. For example, recipient data 202, content delivery action data 204, and contextual data 206 are either determined and received during the generation of prediction training data 208 or determined and stored in data store 140 for retrieval during the generation of prediction training data 208.

In some embodiments, content action delivery determination component 150 determines which content delivery actions to determine content action delivery decisions for and the order in which to determine them for different use cases for the content delivery. For example, for an email advertisement, as described in further detail below, content action delivery determination component 150 can use content delivery actions such as which product to advertise, whether to even send the advertisement, and the content of the advertisement. In another example, for a content-to-request matching process, as described in further detail below, content action delivery determination component 150 can use content delivery actions such as whether to bid, what price to bid, and what keyword to bid on. Further details regarding these content action delivery decisions and how they are made are described below.

The term content delivery action, as used throughout the description, refers to an aspect of a content delivery to an end user of the computing system 200. The term content action delivery decision refers to the decision determined by content action delivery determination component 150 for that aspect (e.g., for that content delivery action). For example, content delivery actions are aspects of content delivery such as whether to send content to a specific end user of computing system 200, the medium through which to send the content, and/or the format/substance of the content itself and the associated contact action delivery decisions are to send the content through email using text. In an alternative example, content delivery actions include what keyword to place a bid on in a content-to-request matching process, as well as the price of that bid.

In one example, the recipient of the content delivery action is the end user that will receive a content delivery (e.g., a recipient of an email). The term campaign refers to different groups of related content. For example, a campaign can be an ad campaign to advertise a product and the related content can be different options for how the same product can be advertised. In such an example, the actual content (e.g., content delivery 218) being delivered to the user (e.g., a user of user system 110) may vary depending on the content action delivery decisions determined by content action delivery determination component 150 even for the same campaign. For example, a product associated with the campaign can be presented to a user of user system 110 in an email, banner ad, and/or in-line with an interface of application software system 130. Similarly, the content of the email, banner ad, and/or in-line presentation can include different presentation formats such as text, images, audio, video, and/or other media formats as well as different options for the presentation formats (e.g., different text options). In such an example, recipient data 202 includes data for a number of campaigns the user interacted with within a period of time, data for how many campaigns were sent to that user within a period of time, feature vectors associated with a profile associated with the user, demographic information for the user, and similar feature data.

In some embodiments, the content delivery actions concerning the presentation format include different options for types of media to display to the user for the content delivery. For example, some users may respond better to content deliveries with a lot of text while others respond better to content deliveries with images. Additionally, the media itself can change based on the user. For example, different users may respond differently to different images and/or different wording in text. By evaluating these different presentation formats using data from the user, the computing system 200 can provide a content delivery decisions and therefore ultimately a content delivery that the user responds best to.

In another example, an advertiser has a campaign to advertise one or more products to users of application software system 130 through an automated content-to-request matching process, such as a real-time bidding (RTB) process. In such an example, the recipient of the content delivery action, rather than being an end user, can be, for example, a keyword or keywords being bid on through the automated content-to-request matching process for input to a price auction platform (e.g., user system 110). In such an example, the content delivery actions can include whether to bid on the keyword, how much to bid on the keyword, etc. The recipient data 202 includes information about the keyword being bid on such as a running bid for the keyword, an identifier for the keyword (e.g., embedding representing the keyword), feature data reflecting user interactions with the keyword, and similar feature data.

The content delivery action data 204 includes information about the content delivery action to be determined by content action delivery determination component 150. For example, content delivery action data 204 includes information indicating a product that is the target of the campaign, a business unit associated with that product and/or campaign, and data about the content delivery action itself (e.g., whether the content delivery action is whether to bid on a keyword, how much to bid on a keyword, whether to deliver content, the medium through which to deliver the content, etc.).

In some embodiments, recipient data 202 depends on content delivery action and/or the specific campaign. For example, content action delivery determination component 150 retrieves and/or determines recipient data 202 based on the content delivery action data 204 (such as the product, business unit, and the content delivery action itself). Accordingly, different types of recipient data 202 can be used for different content delivery actions and/or campaigns such that the recipient data 202 used is relevant to that content delivery action and/or campaign.

Contextual data 206 can include contextual information for campaigns, content delivery actions, and recipients. For example, contextual data 206 can include data about a location associated with user system 110, a device identifier associated with user system 110 identifying the kind of device running user system 110, and other similar contextual information. In some embodiments, contextual data 206 depends on content delivery action and/or the specific campaign. For example, content action delivery determination component 150 retrieves and/or determines contextual data 206 based on the content delivery action data 204 (such as the product, business unit, and the content delivery action itself). Accordingly, different types of contextual data 206 can be used for different content delivery actions and/or campaigns such that the contextual data 206 used is relevant to that content delivery action and/or campaign.

Content action delivery determination component 150 receives recipient data 202, content delivery action data 204, and contextual data 206 and generates prediction training data 208 using recipient data 202, content delivery action data 204, and contextual data 206. For example, prediction model input preprocessing component 205 generates a feature vector for each of recipient data 202, content delivery action data 204, and contextual data 206. In some embodiments, prediction model input preprocessing component 205 filters one or more of recipient data 202, content delivery action data 204, and contextual data 206. For example, prediction model input preprocessing component 205 filters recipient data 202 and contextual data 206 using content delivery action data 204 to generate feature vectors that include relevant features.

In some embodiments, prediction model input preprocessing component 205 generates the following feature vectors: xᵣ as the feature vector for the recipient r (e.g., from recipient data 202), x_{α} as the feature vector for the content delivery action α (e.g., from content delivery action data 204), and x_{c} as the feature vector for the contextual data (e.g., from contextual data 206). Prediction model input preprocessing component 205 sends the generated prediction training data 208 to prediction modeling component 215.

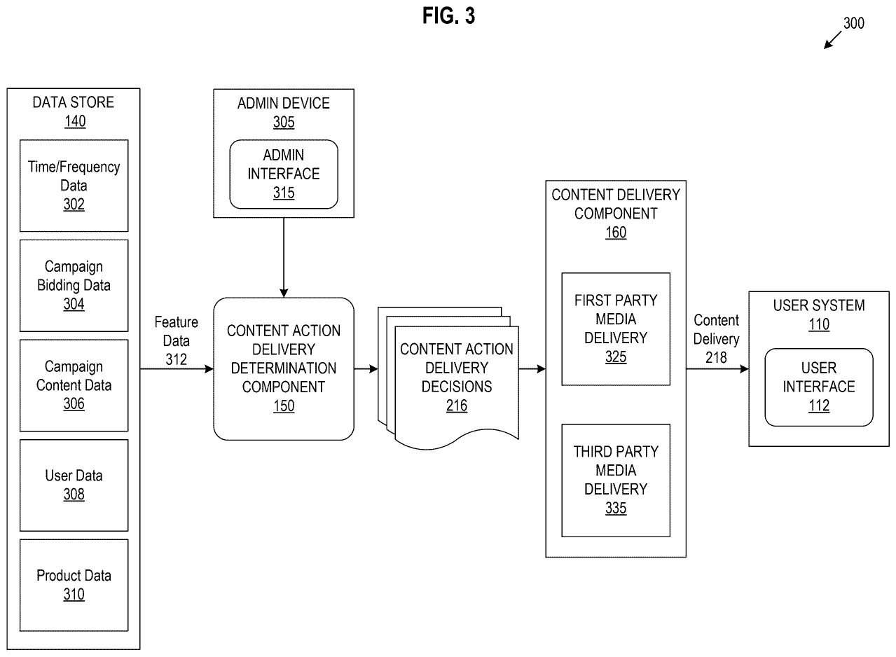

Prediction modeling component 215 receives prediction training data 208 from prediction model input preprocessing component 205 and raw candidates 210 from data store 140. Raw candidates 210 is a list of recipient candidates for content campaigns. For example, raw candidates 210 includes a listing of campaigns and associated candidate recipients for each of the campaigns. In some embodiments, content action delivery determination component 150 determines raw candidates 210 based on received demographic information for each campaign. For example, content action delivery determination component 150 receives demographic information for each of the campaigns and determines users for each of the campaigns based on matching the users with the demographic information. In some embodiments, raw candidates 210 is a list of campaign-user pairs received by an admin device (e.g., admin device 305 of FIG. 3). In some embodiments, prediction modeling component 215 includes a propensity machine learning model to determine propensity data (e.g., complain propensity 212 and conversion propensity 214) for recipients' reactions to campaigns from raw candidates 210 based on the prediction training data 208. Although illustrated separately for purposes of discussion, in some embodiments, prediction modeling component 215 and content delivery decision component 225 are implemented as one. For example, content action delivery determination component 150 determines content action delivery decisions 216 using prediction training data 208 and raw candidates 210.

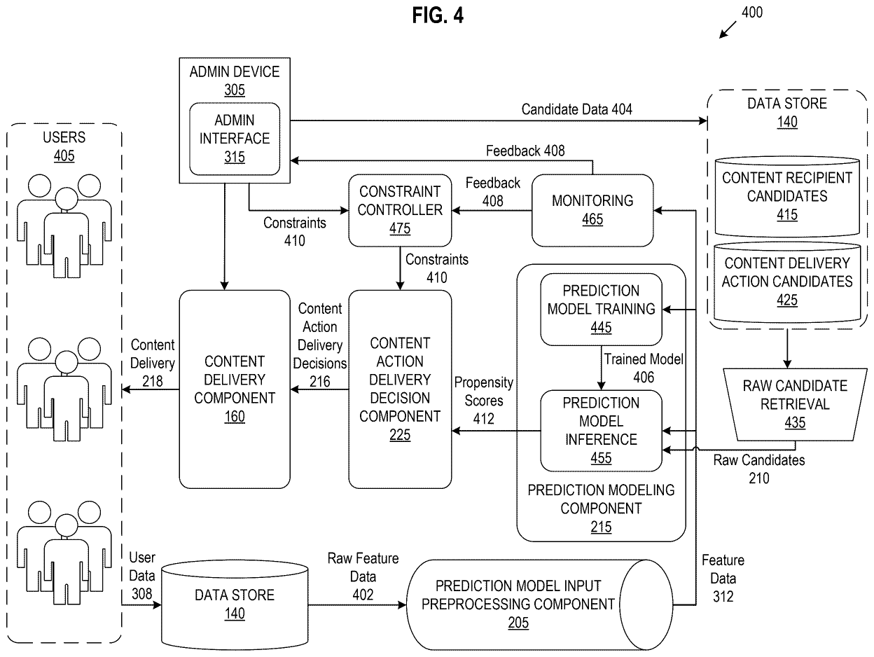

During the training phase of the propensity machine learning model, prediction modeling component 215 trains the propensity machine learning model to determine performance metrics for recipients' predicted reactions to different content action delivery decisions for each campaign. For example, prediction modeling component 215 trains a propensity machine learning model to build a functional mapping of predicted click through rate (CTR), predicted conversion rate, predicted profit per conversion, and/or predicted cost per click (CPC) for different content action delivery decisions using user feedback data (e.g., feedback 408 of FIG. 4). Conversion as used herein refers to a secondary action associated with the content delivery such as subscribing to a product and/or service after clicking the advertisement for that product and/or service. This machine learning model is therefore trained to determine propensities for recipients' reactions to different content delivery action options for each campaign. In some embodiments, prediction modeling component 215 builds a functional mapping based on the equation: y=f(xᵣ, X_{α}, X_{c}), where y represents the predicted metrics, xᵣ, represents the feature vector for the recipient, x_{α} represents the feature vector for the content delivery action, and x_{c} represents the feature vector for the contextual data.

In some embodiments, the predicted metrics include a complain propensity 212 and a conversion propensity 214. For example, prediction modeling component 215 trains the propensity machine learning model to predict a complain propensity 212 modeling the probability of an active negative reaction by a recipient such as unsubscribing from an email, responding negatively to an email, etc.). Prediction modeling component 215 also trains the propensity machine learning model to predict a conversion propensity 214 modeling the probability of an active positive reaction by a recipient such as the recipient subscribing to a product offered in the content delivery.

In some embodiments, the predicted metrics include a click propensity. For example, prediction modeling component 215 trains the propensity machine learning model to predict the click propensity modeling the probability of the recipient interacting with the content delivery (even if the recipient does not end up subscribing). By including a click propensity metric, the computing system 200 can better model silent churn. Silent churn refers to recipients who stop responding to and/or engaging with content delivery without explicitly complaining or unsubscribing. Accordingly, in the embodiments using click propensity, the computing system 200 can determine content action delivery decisions based on explicitly positive and negative reactions (e.g., conversion and complain) as well as implicitly positive and negative reactions (e.g., clicking or not clicking the content delivered). Accordingly, the computing system 200 can determine when not to send content to recipients to avoid the recipients disengaging from all content deliveries. This allows the system to more quickly converge of content action delivery decisions that optimize the user experience. Prediction modeling component 215 sends the generated performance metrics (e.g., complain propensity 212, conversion propensity 214, and click propensity) to content delivery decision component 225.

In some embodiments, prediction modeling component 215 uses supervised learning methods to estimate f (xᵣ, x_{α}, x_{c}) from user feedback. For example, prediction modeling component 215 can use combinations of different machine learning methods depending on the amount of data available to the system. In some embodiments, when the amount of training data (e.g., prediction training data 208) is relatively small, prediction modeling component 215 trains the propensity machine learning models using regression modeling. In some embodiments, such as when the amount of training data (e.g., prediction training data 208) is larger than in the regression modeling case, prediction modeling component 215 uses a gradient boosted decision tree machine learning model (such as an XGBoost model). In some embodiments, such as when there is a relatively large amount of training data (e.g., prediction training data 208), prediction modeling component 215 can use deep neural networks. For example, prediction modeling component 215 can use a transformer architecture to generate embeddings for historical user interactions and determine the performance metrics (e.g., complain propensity 212, conversion propensity 214, and click propensity) based on generated embeddings. In some embodiments, such as when prediction modeling component 215 is using a single machine learning model to generate multiple metrics, prediction modeling component 215 can use a multi-task machine learning architecture such as multi-gate mixture-of-experts (MMOE) and/or entire space multi-task model (ESMM). Using such a multi-task machine learning architecture can enable prediction modeling component 215 to better exploit the relationship between the predicted performance metrics.

In some embodiments, content action delivery determination component 150 uses causal machine learning methods to avoid potential bias in inferencing the performance metrics (e.g., complain propensity 212, conversion propensity 214, and click propensity). For example, without using causal machine learning methods, predicting the performance metrics based on the marketing action can lead to bias when the historical data (e.g., training data and/or historical data for the recipients' past interactions) does not include every possibility for a marketing action. In some embodiments, content action delivery determination component 150 can use causal machine learning methods such as propensity score matching, instrumental variable analysis, difference-in-differences, causal forests, and other similar causal machine learning methods along with the methods described above.

Content delivery decision component 225 receives the performance metrics (e.g., complain propensity 212, conversion propensity 214, and click propensity) from prediction modeling component 215, receives raw candidates 210 from data store 140 and generates content action delivery decisions 216. For example, content delivery decision component 225 chooses the best content action delivery decision (e.g., content action delivery decision 216) for a given recipient based on the performance metrics (e.g., complain propensity 212, conversion propensity 214, and click propensity) from prediction modeling component 215. In some embodiments, content delivery decision component 225 ranks the pairs of content action delivery options and campaigns for each recipient and determines the top campaigns and associated content action delivery decisions.

In some embodiments, content delivery decision component 225 determines an optimal content action delivery decision 216 by modeling the choice as a constrained optimization problem. For example, content delivery decision component 225 optimizes the total predicted value for each content action delivery decision 216 by modeling performance metrics as k=0,1,2, . . . . K where the value of k represents the specific performance metric (e.g., predicted conversion rate) in order of importance (e.g., 0 is the primary metric to be optimized) and K represents the last performance metric (e.g., last metric to be optimized). In some embodiments, priorities for metrics to be optimized are included in hyperparameters within the model and/or in contextual data. With y^{k}=fₖ(xᵣ, x_{α}_{ᵣ}, x_{c}) representing the estimated value of metric k for recipient r in response to content delivery action αᵣ, content delivery decision component 225 can select a best content action delivery decision 216 according to the following equation:

$${max}_{{a}_{r}} {\sum }_{r} {f}_{0} ( {x}_{r} , {x}_{{a}_{r}} , {x}_{c} ) s . t . {\sum }_{r} {f}_{k} ( {x}_{r} , {x}_{{a}_{r}} , {x}_{c} ) \leq {C}_{k} where {y}^{k} for k \geq 1$$

are performance metrics subject to upper bound constraints represented by Ck. Accordingly, content delivery decision component 225 chooses an optimal content action delivery decision 216 based on maximizing one of the performance metrics (e.g., conversion rate) while ensuring the remaining performance metrics fall within provided constraints (e.g., less than a certain number of recipients unsubscribe in response to the content action delivery decision). Content action delivery determination component 150 can address this optimization problem (and therefore determine content action delivery decision 216) through combinations of different machine learning approaches. For example, content action delivery determination component 150 can employ linear programming (LP), reinforcement learning (RL), contextual bandits, Q-learning, and combinations of these and similar machine learning models to choose an optimal content action delivery decision 216 based on recipient data 202, content delivery action data 204, contextual data 206, and raw candidates 210. In some embodiments, for reinforcement learning models, content action delivery determination component 150 determines content action delivery decisions 216 that maximize a reward function for a current state of the system based on recipient data 202, content delivery action data 204, and contextual data 206. For example, the state of the system can be represented by feature vectors (e.g., xᵣ, x_{α}_{ᵣ}, x_{c}) and content action delivery determination component 150 trains a reinforcement learning model to determine content action delivery decisions that maximize the expected rewards for the current state.

In some embodiments, content action delivery determination component 150 determines content action delivery decisions 216 in the context of an automated content-to-request matching process. For example, content action delivery determination component 150 determines optimal content action delivery decisions for whether to place a bid for a specific keyword (e.g., recipient) as well as a price to place for that bid. In some embodiments, content action delivery determination component 150 uses feature data (e.g., recipient data 202, content delivery action data 204, and contextual data 206) including hourly or daily ads winning performance metrics (represented as xₚ). For example, xₚ can include data on the average position for each keyword or impression winning percentage for each campaign. In such embodiments, content action delivery determination component 150 can train propensity machine learning models to predict: number of clicks (represented as y^{clicks}=f_{clicks}(xᵣ, xₚ)), cost per clock (CPC)(represented as y^{cpc}=f_{cpc}(xᵣ, xₚ)), conversion rate (represented as y^{cvr}=f_{cvr}(xᵣ)), and revenue per conversion (RPC)(represented as y^{rpc}=f_{rpc}(xᵣ)).

As shown above, the calculation of conversion rate and RPC performance metrics do not depend on the ads winning performance metrics as they represent rates that occur after the initial click. In such an embodiment, content action delivery determination component 150 can determine optimal recipients (e.g., keywords) for determining a bid according to the following formula:

$${max}_{p ( r )} {\sum }_{r} {y}_{r , p ( r )}^{rev} s . t . \frac{{\sum }_{r} {y}_{r , p ( r )}^{rev}}{{\sum }_{r} {y}_{r , p ( r )}^{cost}} \geq {C}_{ROAS} , where {y}_{r , p ( r )}^{rev} = {f}_{clicks} ( {x}_{r} , {x}_{p} ) {f}_{cvr} ( {x}_{r} ) {f}_{rpc} ( {x}_{r} )$$

and represents the predicted revenue for an index p of winning performance based on the predicted number of clicks, predicted conversion rate, and predicted revenue per conversion,

$${y}_{r , p ( r )}^{cost} = {f}_{clicks} ( {x}_{r} , {x}_{p} ) {f}_{cpc} ( {x}_{r} , {x}_{p} )$$

and represents the predicted cost for the index p based on the predicted number of clicks and predicted cost per click, and C_{ROAS} is the constraint representing the level of return-on-ads-spends (ROAS). Accordingly, content action delivery determination component 150 determines the recipient (e.g., keyword) to bid on by optimizing the expected performance metrics for that recipient while ensuring that the predicted revenue divided by the predicted cost for the campaign as a whole satisfies the ROAS constraint. Once the content action delivery determination component 150 determines the optimal recipient

$$\\ {x}_{p}^{*}$$

(e.g., the first content action delivery decision 216), content action delivery determination component 150 can then calculate the optimal bid according to the following formula:

$$\\ {a}_{r}^{*} = {f}_{cpc} ( {x}_{r} , {x}_{p}^{*} ) , where {a}_{r}^{*}$$

is the optimal bid (e.g., the second content action delivery decision 216) and

$$\\ {x}_{p}^{*}$$

is the determined optimal recipient.

Content action delivery determination component 150 sends these content action delivery decisions to content delivery component 160 which causes content delivery 218 to user system 110 based on the determined content action delivery decisions 216. For example, multiple decisions are made (e.g., content action delivery decisions) in multiple passes for different aspects of the content delivery and the multiple decisions are compiled into a single content delivery based on the determined delivery decisions. In continuing with the above example for an automated content-to-request matching process, content delivery component 160 puts together the content action delivery decisions for the optimal recipient

$$\\ {x}_{p}^{*}$$

(e.g., keyword) and the optimal bid

$$\\ {a}_{r}^{*}$$

and, in the first price auction platforms, uses this combination to bid on the keyword (e.g., send content delivery 218 as a bid

$$\\ {a}_{r}^{*}$$

for the keyword

$$\\ {x}_{p}^{*}$$

to user system 110). In some embodiments, such as in second price auction platforms, content delivery component 160 submits the combination as an expected-cost-per-click (ECPC) bid.

In some embodiments, content action delivery determination component 150 determines content action delivery decisions 216 in the context of content optimization (e.g., for optimizing content presented to users of an online social network or other content sharing platform. For example, content action delivery determination component 150 determines different creator content to present to a user using a multi-dimensional contextual bandit model based on regression model according to the following equation: ρ⁻¹(y)=x^{T}w+∈, where ε~N(0, β²) and is a probability distribution with a mean of 0 and a tunable hyperparameter β as the standard deviation, x=xᵣ, x_{α}, x_{r,α} and is a feature vector including recipient features (e.g., xᵣ), content delivery action features (e.g., x_{α}), and pair features for the pair of recipient and content delivery action (e.g., x_{r,α}), y is the observed reward, ρ is a link function, and

$$\\ {w}_{i} \sim N ( {μ}_{{w}_{i}} , {σ}_{{w}_{i}}^{2} )$$

and is a learned weight function with mean μ and standard deviation σ. In such an embodiment, content action delivery determination component 150 trains the machine learning model to generate content action delivery decisions by, for example, determining the weights using factor graph and expectation propagation with sampling (e.g., Thompson sampling) to obtain predicted rewards for different pairs of recipients and content action delivery decisions 216 (e.g., different creators). In some embodiments, content delivery component 160 receives these content action delivery decisions 216 from content action delivery component 150 and sends content delivery 218 to user system 110 causing the creators associated with the content action delivery decisions 216 to be displayed to a user of user system 110.

In some embodiments, content action delivery determination component 150 determines content action delivery decisions 216 in the context of email marketing. For example, content action delivery determination component 150 determines content action delivery decisions 216 for whether to send a specific recipient (e.g., an end user) an email notification as well as what email notification to send. In some embodiments, the computing system 200 operates under a content delivery model to deliver both business to business (B2B) (B2B) as well as business to consumer (B2C) products. The feedback received from users (e.g., feedback 408 of FIG. 4) which content action delivery determination component 150 uses to train the machine learning models can vary substantially in time between B2B and B2C products. For example, business to business relationships tend to be more long-term and short-term calculations of value may not accurately represent the value of the content action delivery decision. Accordingly, in such embodiments, content action delivery determination component 150 can train machine learning models to create a functional mappings for both short-term and long-term value models. In some embodiments, content action delivery determination component 150 creates functional mappings for predicting the conversion propensity 214 (represented by

$$\\ {y}_{r , a}^{conv} = {f}_{conv} ( {x}_{r} , {x}_{a} , {x}_{c} ) )$$

and complain propensity 214 (represented by

$$\\ {y}_{r , a}^{comp} = {f}_{comp} ( {x}_{r} , {x}_{a} , {x}_{c} ) ) ,$$

where xᵣ is recipient features (e.g., from recipient data 202) x_{α} is content delivery action features (e.g., from content delivery action data 204), and x_{c} is contextual features (e.g., from contextual data 206). In such embodiments, xᵣ includes features from profile information, demographic information, and other behavioral data), x_{α} includes information about content delivery actions (e.g., whether to send an email to recipient), and x_{c} includes other contextual information as described in more detail above.

In embodiments using long-term value estimations, content action delivery determination component 150 also creates functional mappings for predicting the long-term value for a potential conversion. For example, content action delivery determination component 150 determines long-term value data represented by

$$\\ {y}_{r , p}^{ltv} = {f}_{ltv} ( {x}_{r} , {x}_{p} , {x}_{c} ) p ,$$

where p is the index for the product that the content delivery action α is promoting. In some embodiments, content action delivery determination component 150 trains the long-term value model to predict y^{ltv} based on a gamma loss function, such as

$$\\ L = {\sum }_{i} [ {μ}_{i} k + {q}_{i}^{lti} exp ( - {μ}_{i} ) k ]$$

where k is a tunable shape hyperparameter, i is the training data index,

$$\\ {q}_{i}^{lt}$$

is the observed long-term metric (e.g., a metric determined over a long-term such as twelve months to represent performance over that time period), and

$$\\ {μ}_{i} = log ( {y}_{i}^{ltv} ) .$$

In some embodiments, content action delivery determination component 150 trains the long-term value model using shorter-term value model predictions as features. For example, content action delivery determination component 150 can train value models with

$$\\ {q}_{i}^{lt}$$

for three months, six months, nine months, and twelve months. In such embodiments, content action delivery determination component 150 uses the value estimation for the shorter-term value models as a feature for the longest-term value model (e.g., twelve month model). It should be noted that the terms short-term and long-term as well as their comparative and superlative counterparts are used herein to describe differing periods of time over which data is collected and analyzed by computing system 200. Therefore, while specific values are occasionally provided, the techniques can be used on various different time scales so long as the relationship between short-term and long-term remains somewhat standard. For example, while described with reference to months, the same techniques can be applied to similar systems on the timescales of seconds and/or years. By providing shorter-term value predictions to the long-term value model, content action delivery determination component 150 can generate content action delivery decisions 216 that are able to respond more quickly than otherwise possible if only considering the long-term value predictions, while still maintaining a long-term value representation that affords better predictions over longer time periods.

FIG. 3 illustrates another example computing system 300 that includes content action delivery determination component 150. As shown in FIG. 3, computing system 300 also includes data store 140, admin device 305, content delivery component 160, and user system 110. Data store includes time/frequency data 302, campaign bidding data 304, campaign content data 306, user data 308, and product data 310. Time/frequency data 302 includes data relating to the time and frequency of historical and/or ongoing content delivery. Campaign bidding data 304 includes data relating to historical and/or ongoing bidding data for campaigns (e.g., product advertisement campaigns). Campaign content data 306 includes data relating to historical and/or ongoing campaigns such as information about how a product is advertised in that campaign. User data 308 includes data about an end user of computing system 300, such as profile data, demographic data, and/or historical interaction data. Product data 310 includes data about a product that is the target of a historical and/or ongoing campaign.

As shown in FIG. 3, content delivery component 160 includes components for sending content delivery 218 through different avenues to a user system 110. For example, content delivery component 160 includes first party media delivery 325 for sending content delivery 218 through an application software system co-owned and/or otherwise intimately connected with content delivery component (e.g., application software system 130 of FIG. 1). Content delivery component 160 may also include third party media delivery for sending content delivery 218 through a third-party application software system. For example, third party media delivery 335 can include an interface for content delivery component 160 to submits bids to third-party price auction platforms.

Admin device 305 includes at least one computing device, such as a personal computing device, a server, or a mobile computing device. Admin device 305 includes at least one software application, including an admin interface 315, installed on or accessible by a network to a computing device (e.g., network 120 of FIG. 1). For example, admin interface 315 can be or include a front-end portion of an application software system (e.g., application software system 130 of FIG. 1).

Admin interface 315 is any type of user interface as described with reference to FIG. 1. Admin interface 315 can be used to interact with applications or programs and view or otherwise perceive output that includes data produced by application software system 130 and/or other components of computing systems 100, 200, 300, and 400. For example, admin interface 315 can include a graphical user interface that includes a mechanism for viewing feedback (e.g., feedback 408 of FIG. 4) and/or other digital content, such as content related to computing systems 100, 200, 300, and 400. By way of another example, admin interface 315 can include an interface for entering data (e.g., constraints 410 and/or candidate data 404 of FIG. 4, raw candidates 210 of FIG. 2, and/or other digital content relating to computing systems 100, 200, 300, and 400. Examples of admin interface 315 include web browsers, command line interfaces, and mobile apps. Admin interface 315 as used herein can include application programming interfaces (APIs).

A client portion of an application software system (e.g., application software system 130) can operate in admin device 305, for example as a plugin or widget in a graphical user interface of a software application or as a web browser executing admin interface 315. In an embodiment, a web browser can transmit an HTTP request over a network (e.g., the Internet) in response to user input that is received through a user interface provided by the web application and displayed through the web browser. A server running the application software system and/or a server portion of the application software system can receive the input, perform at least one operation using the input, and return output using an HTTP response that the web browser receives and processes.

While not specifically shown, it should be understood that admin device 305 can include an interface embodied as computer programming code stored in computer memory that when executed causes a computing device to enable bidirectional communication with any other components of computing systems 100, 200, 300, and 400 using a communicative coupling mechanism. Examples of communicative coupling mechanisms include network interfaces, inter-process communication (IPC) interfaces and application program interfaces (APIs). Admin device 305 may be implemented using at least one computing device that is communicatively coupled to an electronic communications network (e.g., network 120 of FIG. 1). A typical user of admin device 305 can be an administrator of a campaign or administrator of one or more components of computing systems 100, 200, 300, and 400.

As shown in FIG. 3, content action delivery determination component 150 receives feature data 312 from data store 140. In some embodiments, feature data 312 includes time/frequency data 302, campaign bidding data 304, campaign content data 306, user data 308, and/or product data 310. As described in further detail with reference to FIG. 2, content action delivery determination component 150 determines content action delivery decisions 216 using feature data 312. It will be appreciated that the recipient data 202, content delivery action data 204, and contextual data 206 can be described as included in time/frequency data 302, campaign bidding data 304, campaign content data 306, user data 308, and/or product data 310 for different applications as explained in FIG. 2. For example, for an automated content-to-request matching process context, the recipient data 202 includes campaign bidding data 304 while for an email marketing context, the recipient data 202 includes user data 308. The different types of feature data 312 illustrated as included in data store 140 is for the purpose of illustration and is not meant to be limiting.

In some embodiments, content action delivery determination component 150 receives data from admin device 305. For example, content action delivery determination component 150 can receive raw candidates 210 and/or constraints for determining content action delivery decisions 216 as explained with reference to FIG. 2. Further details regarding constraints and admin device 305 are described with reference to FIG. 4.

Content action delivery determination component 150 sends content action delivery decisions 216 to content delivery component 160 for sending content delivery 218 to user system 110. For example, content delivery component 160 receives content action delivery decisions 216 and determines how to send content delivery 218. In some embodiments, content delivery component 160 sends content delivery 218 using first party media delivery 325. For example, content delivery component 160 causes content delivery 218 based on content action delivery decisions 216 to be presented on user interface 112 of user system 110 through an associated application software system (e.g., application software system 130 of FIG. 1). In some embodiments, content delivery component 160 sends content delivery 218 using third party media delivery 335. For example, content delivery component 160 causes content delivery 218 based on content action delivery decisions 216 to be submitted to a price auction platform (e.g., user system 110).

FIG. 4 illustrates another example computing system 400 that includes content action delivery determination component 150. As shown in FIG. 3, computing system 400 also includes data store 140, prediction model input preprocessing component 205, prediction modeling component 215, content action delivery decision component 225, content delivery component 160, users 405, admin device 305, constraint controller 475, raw candidate retrieval 435, and monitoring 465. Prediction modeling component 215 includes prediction model training 445 and prediction model inference 455.

As shown in FIG. 4, data store 140 receives user data 308 from users 405. For example, users 405 are associated with user devices (e.g., user system 110 of FIG. 1). Users 405 interact with their respective user devices (e.g., via a user interface such as user interface 112) to input user data 308 to their associated profiles. In some embodiments, user data 308 includes profile data, historical interaction data, and demographic data as described in more detail with reference to FIG. 2. In some embodiments, an application software system (e.g., application software system 130 of FIG. 1) receives user data 308 and stores user data 308 in data store 140.

Prediction model input preprocessing component 205 receive raw feature data 402 from data store 140. For example, as described in further detail with reference to FIGS. 2 and 3, prediction model input preprocessing component 205 receives raw feature data for content delivery actions, campaigns, and recipients (e.g., recipient data 202, content delivery action data 204, contextual data 206, time/frequency data 302, campaign bidding data 304, campaign content data 306, user data 308, and/or product data 310). Prediction model input preprocessing component 205 generates feature data 312 using raw feature data 402. For example, feature data 312 is the actual feature vectors used to during training and/or inference of the propensity machine learning models trained and executed by prediction modeling component 215. In some embodiments, prediction model input preprocessing component 205 generates feature data 312 by filtering and/or reformatting raw feature data 402. Prediction model input preprocessing component 205 sends feature data 312 to prediction modeling component 215 and monitoring 465.

During the training phase for prediction modeling component 215, prediction model training 445 receives feature data 312 from prediction model input preprocessing component and trains a propensity machine learning model (e.g., trained model 406) to determine propensity scores (e.g., propensity scores 412) and/or determine optimal content action delivery decisions 216 based on feature data 312. Further details regarding the optimization methods for training propensity machine learning models are discussed with reference to FIG. 2.

During the inference phase for prediction modeling component 215, prediction modeling component 215 receives raw candidates 210 from raw candidate retrieval 435. For example, prediction modeling component 215 retrieves raw candidates 210 from a list of content recipient candidates 415 and content delivery action candidates 425 stored in data store 140. In some embodiments, as shown in FIG. 4, data store receives candidate data 404 for content recipient candidates 415 and content delivery action candidates 425 from admin device 305. For example, an administrator interacts with admin interface 315 to cause admin device 305 to send candidate data 404 including pairs of users and campaigns with associated content delivery actions. Prediction model inference uses 210 raw candidates, feature data 312, and the trained model 406 received by prediction model training 445 to generate propensity scores 412 (and/or content action delivery decisions 216). Further details regarding generate propensity scores 412 and/or content action delivery decisions 216 are discussed with reference to FIG. 2.

In some embodiments, content action delivery decision component 225 receives propensity score 412 from prediction modeling component and receives constraints 410 from constraint controller 475 and generates content action delivery decisions 216. For example, constraints 410 represents constraints for computing system 400. In some embodiments, constraints 410 include constraints on performance metrics included in propensity scores 412. For example, constraints 410 include a complaint threshold (e.g., a maximum number of predicted complaints for a campaign, unit, and/or for the system as a whole), a click threshold (e.g., a minimum number of predicted clicks for a campaign and/or for the system as a whole), a volume threshold (e.g., a minimum send volume for a specific campaign, unit, and/or system as a whole), a message threshold (e.g., a maximum number of content deliveries received by a single user of users 405), and similar constraints.

As explained above with reference to FIG. 2, computing system 400 determines multiple content action delivery decisions 216 that address different aspects of content delivery 218 (e.g., different content delivery actions) in multiple passes through computing system 400. In some embodiments, the same machine learning models are used for different content delivery actions such that these models are trained to incorporate an understanding of the other related content delivery actions such that the individual content action delivery decisions 216 that make up the ultimate content delivery 218 incorporate knowledge of the other content delivery actions (e.g., other aspects of content delivery 218).

In some embodiments, content action delivery decision component 225 maximizes a performance metric of propensity scores 412 while ensuring that the remaining performance metrics satisfy constraints 410. For example, content action delivery decision component 225 determines content action delivery decisions such that the conversion propensity is maximized by ensuring that the other performance metrics mentioned above satisfy their respective constraints.

In some embodiments, constraints 410 includes adaptive heuristics. For example, constraints 410 includes cool-off rules so that a user does not receive more than a given number of content deliveries in a fixed period of time and epsilon greedy exploration which ensures that selection bias is measured and taken into account.

In some embodiments, as shown in FIG. 4, constraint controller 475 sends constraints 410 to content action delivery decision component 225. In some embodiments, constraint controller 475 updates constraints 410 based on received user feedback 408. For example, constraint controller 475 receives initial constraints 410 from admin device 305 and in response to a user of users 405 interacting with their respective user device to send feedback 408, constraint controller 475 updates constraints 410 based on the received feedback. In one example, in response to users unsubscribing after receiving a number of emails less than the maximum number of emails in constraints 410, constraint controller 475 updates constraints 410 to reduce the maximum number of emails.

In some embodiments, constraint controller 475 tracks an observed cost represented by C_{obs} (e.g., via feedback 408). Constraint controller 475 can then update constraints 410 based on the original constraints 410 received by admin device 305 such content action delivery determination component 150 uses an updated cost represented by C′=g (C, C_{obs}), where g is the function for adjusting constraints 410 based on feedback 408 as the input for optimization rather than the original budget C. This can help to prevent under-utilization or over-utilization.

As shown in FIG. 4, content action delivery decision component 225 sends the content action delivery decisions 216 determined based on propensity scores 412 and constraints 410 to content delivery component 160 to deliver as content delivery 218 to users 405. Further details regarding content action delivery decisions 216 and content delivery 218 are discussed with reference to FIG. 2.

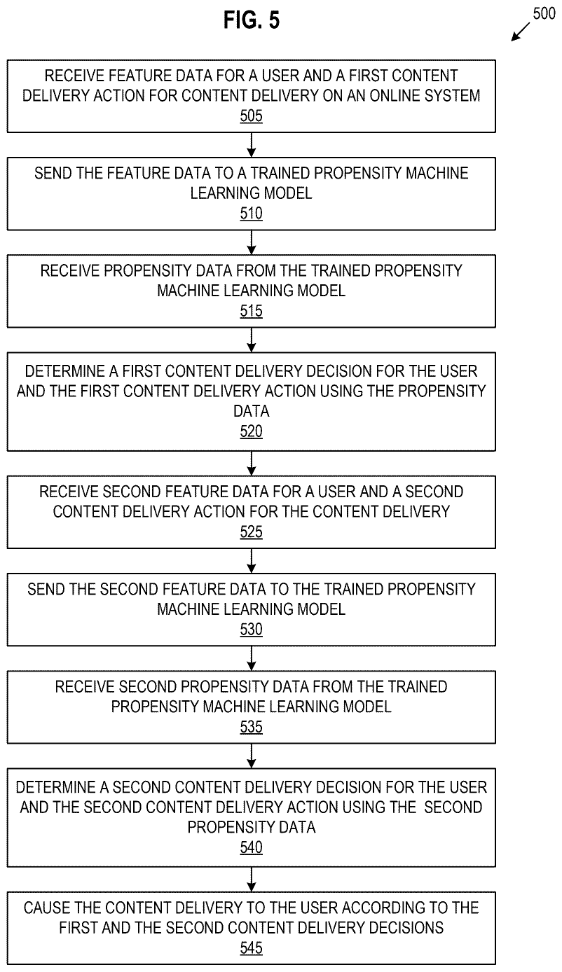

FIG. 5 is a flow diagram of an example method 500 to deliver content using multi-stage content delivery action determination in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by content action delivery determination component 150 of FIG. 1. In other embodiments, the method 500 is performed by content delivery component 160 of FIG. 1. In still other embodiments, parts of the method 500 are performed by content action delivery determination component 150 and parts of the method 500 are performed by content delivery component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing device receives feature data for a user and a first content delivery action for content delivery of an online system. For example, content action delivery determination component 150 receives recipient data 202, content delivery action data 204, and contextual data 206 from data store 140. Further details regarding receiving feature data for the user and the first content delivery action for content delivery as described with reference to FIGS. 2-4.

At operation 510, the processing device sends the feature data to a trained propensity machine learning model. For example, content action delivery determination component 150 sends prediction training data 308 to prediction modeling component 215. Further details regarding sending the feature data to a trained propensity machine learning model are described with reference to FIGS. 2-4.

At operation 515, the processing device receives propensity data from the trained propensity machine learning model. For example, content delivery decision component 225 receives complain propensity 212 and conversion propensity 214 from prediction modeling component 215. Further details regarding receiving propensity data from the trained propensity machine learning model are described with reference to FIGS. 2-4.

At operation 520, the processing device determines a first content delivery decision for the user and the first content delivery action using the propensity data. For example, content delivery decision component 225 determines content action delivery decision 216 using complain propensity 212 and conversion propensity 214. Further details regarding determining a first content delivery decision for the user and the first content delivery action using the propensity data are described with reference to FIGS. 2-4.

At operation 525, the processing device receives second feature data for the user and a second content delivery action for the content delivery. For example, content action delivery determination component 150 receives a second batch of recipient data 202, content delivery action data 204, and contextual data 206 from data store 140. This feature data relates to the second content delivery action to be determined by content action delivery determination component 150. Further details regarding receiving second feature data for the user and a second content delivery action for the content delivery are described with reference to FIGS. 2-4.

At operation 530, the processing device sends the second feature data to the trained propensity machine learning model. For example, content action delivery determination component 150 sends prediction training data for the second feature data (e.g., relating to the second content delivery action) to prediction modeling component 215. Further details regarding sending the second feature data to the trained propensity machine learning model are described with reference to FIGS. 2-4.

At operation 535, the processing device receives second propensity data from the trained propensity machine learning model. For example, content delivery decision component 225 receives complain propensity and conversion propensity for the second content delivery action from prediction modeling component 215. Further details regarding receiving second propensity data from the trained propensity machine learning model are described with reference to FIGS. 2-4.

At operation 540, the processing device determines a second content delivery decision for the user and the second content delivery action using the second propensity data. For example, content delivery decision component 225 determines a second content action delivery decision for the second content delivery action using complain propensity and conversion propensity. Further details regarding determining a second content delivery decision for the user and the second content delivery action using the second propensity data are described with reference to FIGS. 2-4.

At operation 545, the processing device causes the content delivery to the user based on the first and the second content delivery decisions. For example, content delivery component 160 creates content delivery 218 based on the first and second content action delivery decisions and sends content delivery 218 to user system 110. Further details regarding causing the content delivery to the user based on the first and the second content delivery decisions are described with reference to FIGS. 2-4.

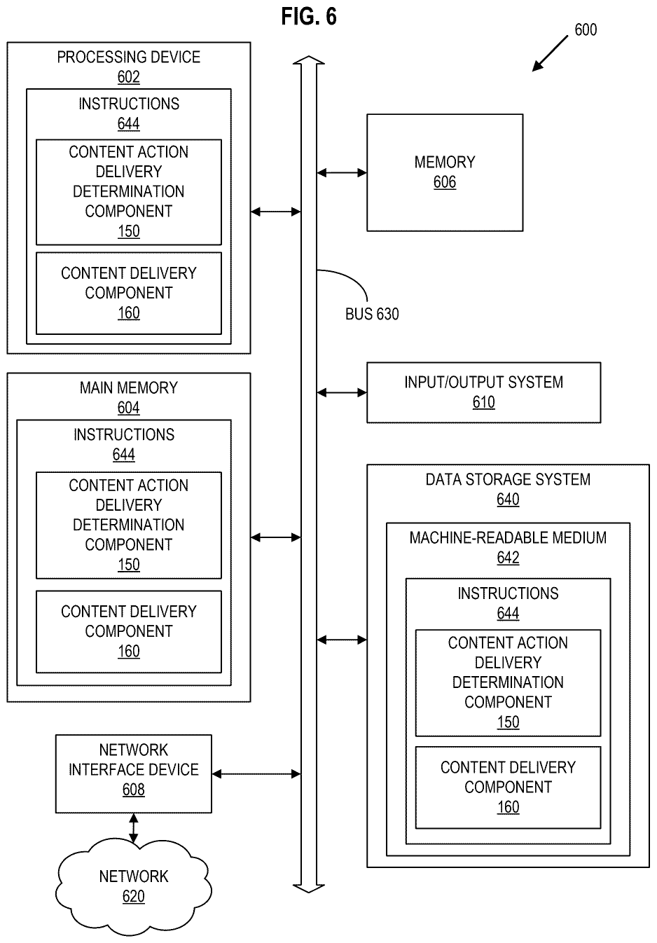

FIG. 6 illustrates an example machine of a computer system 600 within which a set of instructions for causing the machine to perform any one or more of the methodologies discussed herein, can be executed. In some embodiments, the computer system 600 can correspond to a component of a networked computer system (e.g., computing system 100 of FIG. 1) that includes, is coupled to, or utilizes a machine to execute an operating system to perform operations corresponding to content action delivery determination component 150 and/or content delivery component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a memory 606 (e.g., flash memory, static random-access memory (SRAM), etc.), an input/output system 610, and a data storage system 640, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 644 for performing the operations and steps discussed herein.

The computer system 600 can further include a network interface device 608 to communicate over the network 620. Network interface device 608 can provide a two-way data communication coupling to a network. For example, network interface device 608 can be an integrated-services digital network (ISDN) card, cable modem, satellite modem, or a modem to provide a data communication connection to a corresponding type of telephone line. As another example, network interface device 608 can be a local area network (LAN) card to provide a data communication connection to a compatible LAN. Wireless links can also be implemented. In any such implementation, network interface device 608 can send and receive electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system computer system 600.

Computer system 600 can send messages and receive data, including program code, through the network(s) and network interface device 608. In the Internet example, a server can transmit a requested code for an application program through the Internet and network interface device 608. The received code can be executed by processing device 602 as it is received, and/or stored in data storage system 640, or other non-volatile storage for later execution.

The input/output system 610 can include an output device, such as a display, for example a liquid crystal display (LCD) or a touchscreen display, for displaying information to a computer user, or a speaker, a haptic device, or another form of output device. The input/output system 610 can include an input device, for example, alphanumeric keys and other keys configured for communicating information and command selections to processing device 602. An input device can, alternatively or in addition, include a cursor control, such as a mouse, a trackball, or cursor direction keys for communicating direction information and command selections to processing device 602 and for controlling cursor movement on a display. An input device can, alternatively or in addition, include a microphone, a sensor, or an array of sensors, for communicating sensed information to processing device 602. Sensed information can include voice commands, audio signals, geographic location information, and/or digital imagery, for example.

The data storage system 640 can include a machine-readable storage medium 642 (also known as a computer-readable medium) on which is stored one or more sets of instructions 644 or software embodying any one or more of the methodologies or functions described herein. The instructions 644 can also reside, completely or at least partially, within the main memory 604 and/or within the processing device 602 during execution thereof by the computer system 600, the main memory 604 and the processing device 602 also constituting machine-readable storage media.

In one embodiment, the instructions 644 include instructions to implement functionality corresponding to a content action delivery determination component (e.g., content action delivery determination component 150 of FIG. 1). In another embodiment, the instructions 644 include instructions to implement functionality corresponding to a content delivery component (e.g., content delivery component 160 of FIG. 1). In yet another embodiment, the instructions 644 include instructions to implement functionality corresponding to both a content action delivery determination component and a content delivery component (e.g., content action delivery determination component 150 and content delivery component 160 of FIG. 1). While the machine-readable storage medium 642 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Example 1. A method comprising: receiving feature data for (i) a user of an online system and (ii) a first content delivery action for content delivery on the online system; sending the feature data to a trained propensity machine learning model, wherein the trained propensity machine learning model outputs propensity data using the feature data; receiving, from the trained propensity machine learning model, the propensity data, wherein the propensity data estimates a response by the user to the first content delivery action for the content delivery; determining a first content delivery decision for the user and the first content delivery action using the propensity data; receiving second feature data for (i) the user and (ii) a second content delivery action for the content delivery; sending the second feature data to the trained propensity machine learning model, wherein the trained propensity machine learning model outputs second propensity data using the second feature data; receiving, from the trained propensity machine learning model, the second propensity data, wherein the second propensity data estimates a response by the user to the second content delivery action for the content delivery; determining a second content delivery decision for the user and the second content delivery action using the second propensity data; and causing the content delivery to the user on the online system based on the first and the second content delivery decisions.

Example 2. The method of example 1, wherein the trained machine learning model outputs propensity data including long-term value data and conversion propensity and wherein determining the first content delivery decision uses a long term value, the method further comprising: determining a long-term value for the user and the first content delivery action using the long-term value data and the conversion propensity.

Example 3. The method of any of examples 1-2, further comprising: generating a probability distribution for the propensity data; and determining a propensity sample based on sampling the probability distribution, wherein determining the first content delivery decision uses the propensity sample.

Example 4. The method of example 3, further comprising: determining a propensity standard deviation using the feature data, wherein generating the probability distribution uses the standard deviation.

Example 5. The method of any of examples 1-4, wherein determining a first content delivery decision comprises: applying a trained reinforcement machine learning model to the feature data and the propensity data, wherein the trained reinforcement machine learning model outputs the first content delivery decision that is an optimal action for a state represented by the feature data and the propensity data.

Example 6. The method of any of examples 1-5, wherein the propensity data comprises a plurality of performance metrics, the method further comprising: receiving a constraint for the first content delivery action, wherein the constraint applies to a first performance metric of the plurality performance metrics, wherein the first content delivery decision maximizes a second performance metric while the first performance metric satisfies the constraint.

Example 7. The method of example 6, further comprising: receiving feedback from the online system; and updating the constraint for the first content delivery action using the received feedback.

Example 8. The method of any of examples 6-7, wherein the first performance metric is click propensity which represents a predicted likelihood for the user interacting with the content delivery and the second performance metric is conversion propensity which represents a predicted likelihood for the user performing a secondary action associated with content in the content delivery in response to interacting with the content delivery and wherein receiving the constraint comprises receiving a click threshold.

Example 9. The method of any of examples 1-8, wherein the first content delivery decision represents a first aspect of the content delivery and the second content delivery decisions represents a second aspect of the content delivery that is different than the first content delivery decision and wherein causing the content delivery to the user comprises causing the content delivery to the user with the first aspect and the second aspect.

Example 10. A system comprising: at least one memory device; and a processing device, operatively coupled with the at least one memory device, to: receive feature data for (i) a user of an online system and (ii) a first content delivery action for content delivery on the online system; send the feature data to a trained propensity machine learning model, wherein the trained propensity machine learning model outputs propensity data using the feature data; receive, from the trained propensity machine learning model, the propensity data, wherein the propensity data estimates a response by the user to the first content delivery action for the content delivery; determine a first content delivery decision for the user and the first content delivery action using the propensity data; receive second feature data for (i) the user and (ii) a second content delivery action for the content delivery; send the second feature data to the trained propensity machine learning model, wherein the trained propensity machine learning model outputs second propensity data using the second feature data; receive, from the trained propensity machine learning model, the second propensity data, wherein the second propensity data estimates a response by the user to the second content delivery action for the content delivery; determine a second content delivery decision for the user and the second content delivery action using the second propensity data; and cause the content delivery to the user on the online system based on the first and the second content delivery decisions.

Example 11. The system of example 10, wherein the trained machine learning model outputs propensity data including long-term value data and conversion propensity, wherein determining the first content delivery decision uses a long term value, the method further comprising, and wherein the processing device is further to: determine a long-term value for the user and the first content delivery action using the long-term value data and the conversion propensity.

Example 12. The system of any of examples 10-11, wherein the processing device is further to: generate a probability distribution for the propensity data; and determine a propensity sample based on sampling the probability distribution, wherein determining the first content delivery decision uses the propensity sample.

Example 13. The system of example 12, wherein the processing device is further to: determine a propensity standard deviation using the feature data, wherein generating the probability distribution uses the standard deviation.

Example 14. The system of any of examples 10-13, wherein determining a first content delivery decision comprises: applying a trained reinforcement machine learning model to the feature data and the propensity data, wherein the trained reinforcement machine learning model outputs the first content delivery decision that is an optimal action for a state represented by the feature data and the propensity data.

Example 15. The system of any of examples 10-14, wherein the propensity data comprises a plurality of performance metrics and wherein the processing device is further to: receive a constraint for the first content delivery action, wherein the constraint applies to a first performance metric of the plurality performance metrics, wherein the first content delivery decision maximizes a second performance metric while the first performance metric satisfies the constraint.

Example 16. The system of example 15, wherein the processing device is further to: receive feedback from the online system; and update the constraint for the first content delivery action using the received feedback.

Example 17. The system of any of examples 15-16, wherein the first performance metric is click propensity which represents a predicted likelihood for the user interacting with the content delivery and the second performance metric is conversion propensity which represents a predicted likelihood for the user performing a secondary action associated with content in the content delivery in response to interacting with the content delivery and wherein receiving the constraint comprises receiving a click threshold.

Example 18. The system of any of examples 10-17, wherein the first content delivery decision represents a first aspect of the content delivery and the second content delivery decisions represents a second aspect of the content delivery that is different than the first content delivery decision and wherein causing the content delivery to the user comprises causing the content delivery to the user with the first aspect and the second aspect.

Example 19. A non-transitory computer-readable storage medium comprising instructions that, when executed by a processing device, cause the processing device to: receive feature data for (i) a user of an online system and (ii) a first content delivery action for content delivery on the online system; send the feature data to a trained propensity machine learning model, wherein the trained propensity machine learning model outputs propensity data comprising long-term value data and conversion propensity using the feature data; receive, from the trained propensity machine learning model, the propensity data, wherein the propensity data estimates a response by the user to the first content delivery action for the content delivery; determine a long-term value for the user and the first content delivery action using the long-term value data and the conversion propensity; determine a first content delivery decision for the user and the first content delivery action using the propensity data and the long-term value; receive second feature data for (i) the user and (ii) a second content delivery action for the content delivery; send the second feature data to the trained propensity machine learning model, wherein the trained propensity machine learning model outputs second propensity data comprising second long-term value data and second conversion propensity using the second feature data; receive, from the trained propensity machine learning model, the second propensity data, wherein the second propensity data estimates a response by the user to the second content delivery action for the content delivery; determine a second long-term value for the user and the second content delivery action using the second long-term value data and the second conversion propensity; determine a second content delivery decision for the user and the second content delivery action using the second propensity data and the second long-term value; and cause the content delivery to the user on the online system based on the first and the second content delivery decisions.

Example 20. The non-transitory computer-readable storage medium of example 19, wherein the processing device is further to: generate a probability distribution for the propensity data; and determine a propensity sample based on sampling the probability distribution, wherein determining the first content delivery decision uses the propensity sample.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used, and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented method 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving feature data for (i) a user of an online system and (ii) a first content delivery action for content delivery on the online system;
sending the feature data to a trained propensity machine learning model, wherein the trained propensity machine learning model outputs propensity data using the feature data;
receiving, from the trained propensity machine learning model, the propensity data, wherein the propensity data estimates a response by the user to the first content delivery action for the content delivery;
determining a first content delivery decision for the user and the first content delivery action using the propensity data;
receiving second feature data for (i) the user and (ii) a second content delivery action for the content delivery;
sending the second feature data to the trained propensity machine learning model, wherein the trained propensity machine learning model outputs second propensity data using the second feature data;
receiving, from the trained propensity machine learning model, the second propensity data, wherein the second propensity data estimates a response by the user to the second content delivery action for the content delivery;
determining a second content delivery decision for the user and the second content delivery action using the second propensity data; and
causing the content delivery to the user on the online system based on the first and the second content delivery decisions.

2. The method of claim 1, wherein the trained propensity machine learning model outputs propensity data including long-term value data and conversion propensity and wherein determining the first content delivery decision uses a long term value, the method further comprising:
determining the long-term value for the user and the first content delivery action using the long-term value data and the conversion propensity.

3. The method of claim 1, further comprising:
generating a probability distribution for the propensity data; and
determining a propensity sample based on sampling the probability distribution, wherein determining the first content delivery decision uses the propensity sample.

4. The method of claim 3, further comprising:
determining a propensity standard deviation using the feature data, wherein generating the probability distribution uses the standard deviation.

5. The method of claim 1, wherein determining a first content delivery decision comprises:
applying a trained reinforcement machine learning model to the feature data and the propensity data, wherein the trained reinforcement machine learning model outputs the first content delivery decision that is an optimal action for a state represented by the feature data and the propensity data.

6. The method of claim 1, wherein the propensity data comprises a plurality of performance metrics, the method further comprising:
receiving a constraint for the first content delivery action, wherein the constraint applies to a first performance metric of the plurality of performance metrics, wherein the first content delivery decision maximizes a second performance metric while the first performance metric satisfies the constraint.

7. The method of claim 6, further comprising:
receiving feedback from the online system; and
updating the constraint for the first content delivery action using the received feedback.

8. The method of claim 6, wherein the first performance metric is click propensity which represents a predicted likelihood for the user interacting with the content delivery and the second performance metric is conversion propensity which represents a predicted likelihood for the user performing a secondary action associated with content in the content delivery in response to interacting with the content delivery and wherein receiving the constraint comprises receiving a click threshold.

9. The method of claim 1, wherein the first content delivery decision represents a first aspect of the content delivery and the second content delivery decisions represents a second aspect of the content delivery that is different than the first content delivery decision and wherein causing the content delivery to the user comprises causing the content delivery to the user with the first aspect and the second aspect.

10. A system comprising:
at least one memory device; and
a processing device, operatively coupled with the at least one memory device, to:
receive feature data for (i) a user of an online system and (ii) a first content delivery action for content delivery on the online system;
send the feature data to a trained propensity machine learning model, wherein the trained propensity machine learning model outputs propensity data using the feature data;
receive, from the trained propensity machine learning model, the propensity data, wherein the propensity data estimates a response by the user to the first content delivery action for the content delivery;
determine a first content delivery decision for the user and the first content delivery action using the propensity data;
receive second feature data for (i) the user and (ii) a second content delivery action for the content delivery;
send the second feature data to the trained propensity machine learning model, wherein the trained propensity machine learning model outputs second propensity data using the second feature data;
receive, from the trained propensity machine learning model, the second propensity data, wherein the second propensity data estimates a response by the user to the second content delivery action for the content delivery;
determine a second content delivery decision for the user and the second content delivery action using the second propensity data; and
cause the content delivery to the user on the online system based on the first and the second content delivery decisions.

11. The system of claim 10, wherein the trained propensity machine learning model outputs propensity data including long-term value data and conversion propensity, wherein determining the first content delivery decision uses a long term value, and wherein the processing device is further to:
determine the long-term value for the user and the first content delivery action using the long-term value data and the conversion propensity.

12. The system of claim 10, wherein the processing device is further to:
generate a probability distribution for the propensity data; and
determine a propensity sample based on sampling the probability distribution, wherein determining the first content delivery decision uses the propensity sample.

13. The system of claim 12, wherein the processing device is further to:
determine a propensity standard deviation using the feature data, wherein generating the probability distribution uses the standard deviation.

14. The system of claim 10, wherein determining a first content delivery decision comprises:
applying a trained reinforcement machine learning model to the feature data and the propensity data, wherein the trained reinforcement machine learning model outputs the first content delivery decision that is an optimal action for a state represented by the feature data and the propensity data.

15. The system of claim 10, wherein the propensity data comprises a plurality of performance metrics and wherein the processing device is further to:
receive a constraint for the first content delivery action, wherein the constraint applies to a first performance metric of the plurality of performance metrics, wherein the first content delivery decision maximizes a second performance metric while the first performance metric satisfies the constraint.

16. The system of claim 15, wherein the processing device is further to:
receive feedback from the online system; and
update the constraint for the first content delivery action using the received feedback.

17. The system of claim 15, wherein the first performance metric is click propensity which represents a predicted likelihood for the user interacting with the content delivery and the second performance metric is conversion propensity which represents a predicted likelihood for the user performing a secondary action associated with content in the content delivery in response to interacting with the content delivery and wherein receiving the constraint comprises receiving a click threshold.

18. The system of claim 10, wherein the first content delivery decision represents a first aspect of the content delivery and the second content delivery decisions represents a second aspect of the content delivery that is different than the first content delivery decision and wherein causing the content delivery to the user comprises causing the content delivery to the user with the first aspect and the second aspect.

19. A non-transitory computer-readable storage medium comprising instructions that, when executed by a processing device, cause the processing device to:
receive feature data for (i) a user of an online system and (ii) a first content delivery action for content delivery on the online system;
send the feature data to a trained propensity machine learning model, wherein the trained propensity machine learning model outputs propensity data comprising long-term value data and conversion propensity using the feature data;
receive, from the trained propensity machine learning model, the propensity data, wherein the propensity data estimates a response by the user to the first content delivery action for the content delivery;
determine a long-term value for the user and the first content delivery action using the long-term value data and the conversion propensity;
determine a first content delivery decision for the user and the first content delivery action using the propensity data and the long-term value;
receive second feature data for (i) the user and (ii) a second content delivery action for the content delivery;
send the second feature data to the trained propensity machine learning model, wherein the trained propensity machine learning model outputs second propensity data comprising second long-term value data and second conversion propensity using the second feature data;
receive, from the trained propensity machine learning model, the second propensity data, wherein the second propensity data estimates a response by the user to the second content delivery action for the content delivery;
determine a second long-term value for the user and the second content delivery action using the second long-term value data and the second conversion propensity;
determine a second content delivery decision for the user and the second content delivery action using the second propensity data and the second long-term value; and
cause the content delivery to the user on the online system based on the first and the second content delivery decisions.

20. The non-transitory computer-readable storage medium of claim 19, wherein the processing device is further to:
generate a probability distribution for the propensity data; and
determine a propensity sample based on sampling the probability distribution, wherein determining the first content delivery decision uses the propensity sample.
